(19) United States
(12) Patent Application Publication
(10) Pub. No.: US 2017/0344140 A1
(43) Pub. Date: Nov. 30, 2017

(54) WIRELESS FOB

(71) Applicant: Kevin HENDERSON, Davenport,, FL (US)

(72) Inventor: Kevin Henderson, Davenport, FL (US)

(21) Appl. No.: 15/527,189

(22) PCT Filed: Dec. 23, 2014
(86) PCT No.: PCT/US14/72118

§ 371 Date: May 16, 2017

Related U.S. Application Data
(60) Provisional application No. 62/080,564, filed on Nov. 17, 2014.

(51) Int. Cl. G06F 3/0354; G06F 3/0488; G06F 21/32; G07C 9/00; H04L 29/08; G06F 21/35; H04L 29/06

(52) U.S. Cl. CPC G06F 3/03547; G06F 21/32; G06F 3/04883; G07C 9/00944; G06F 21/35; H04L 63/0853; H04L 63/0861; H04L 67/125; G07C 2009/00984

(57) ABSTRACT

A fob includes a housing, a processor positioned within the housing, and a transceiver positioned within the housing and coupled to the processor. The transceiver is configured to send signals to a remote device. The fob also includes a touchpad supported by the housing and coupled to the processor. The touchpad is operable to discern a plurality of different gestures. Each gesture corresponds to a different signal being sent by the transceiver.

### CROSS-REFERENCE TO RELATED APPLICATIONS

This application claims priority to U.S. Provisional Patent Application No. 62/080,564, filed Nov. 17, 2014, the entire contents of which are incorporated by reference herein.

### FIELD OF THE INVENTION

The present invention relates to wireless devices, such as fobs.

### SUMMARY

In one embodiment, the invention provides a fob including a housing, a processor positioned within the housing, and a transceiver positioned within the housing and coupled to the processor. The transceiver is configured to send signals to a remote device. The fob also includes a touchpad supported by the housing and coupled to the processor. The touchpad is operable to discern a plurality of different gestures. Each gesture corresponds to a different signal being sent by the transceiver.

In another embodiment, the invention provides a method of operating a fob. The fob includes a housing, a processor positioned within the housing, a transceiver positioned within the housing and coupled to the processor, and a touchpad supported by the housing and coupled to the processor. The method includes performing a first gesture on the touchpad, transmitting, by the transceiver, a first signal in response to the first gesture, and performing a second gesture on the touchpad. The second gesture is different than the first gesture. The method also includes transmitting, by the transceiver, a second signal in response to the second gesture. The second signal is different than the first signal.

In yet another embodiment, the invention provides a fob including a housing, a processor positioned within the housing, and a transceiver positioned within the housing and coupled to the processor. The transceiver includes an antenna configured to communicate with remote devices using a first wireless protocol and a second wireless protocol that is different than the first wireless protocol.

Other aspects of the invention will become apparent by consideration of the detailed description and accompanying drawings.

### BRIEF DESCRIPTION OF THE DRAWINGS

FIG. 1 is a perspective view of a fob embodying the invention.

FIG. 2 is a schematic block diagram of the fob.

FIG. 3 illustrates a user performing a gesture on the fob.

FIG. 4 illustrates a user performing another gesture on the fob.

FIG. 5 illustrates a user using a biometric sensor on the fob.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

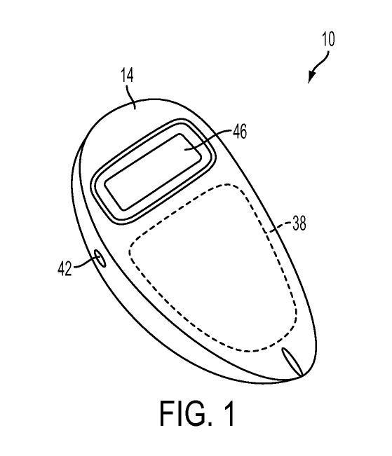

FIG. 1 illustrates a fob 10. The fob 10 is a relatively small, self-contained device that is operable to wirelessly communicate with other devices. By communicating with other devices, the fob 10 can control or initiate functions of those devices. For example, the fob 10 may communicate with a vehicle to lock/unlock the vehicle, open a door of the vehicle, and turn on/turn off the vehicle. The fob 10 may also communicate with a door lock to actuate (e.g., lock and unlock) the door lock. The fob 10 may further communicate with a household appliance (e.g., thermostat, lights, stereo, etc.) to turn the appliance on/off or change a setting of the appliance. As further described below, one fob 10 may be configured to communicate with each of these different devices. It should be appreciated that other types of devices and functions may also be controlled using the fob 10.

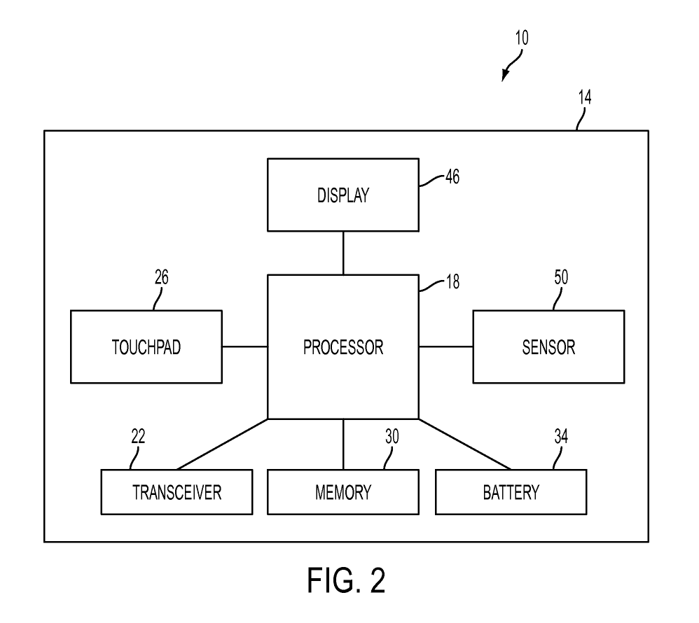

As shown in FIGS. 1 and 2, the illustrated fob 10 includes a housing 14, a processor 18, a transceiver 22, a touchpad 26, a memory 30, and a power source 34. The housing 14, or case, supports the other components of the fob 10. In the illustrated embodiment, the housing 14 is shaped and sized to be comfortably held in a hand of a user. For example, the housing 14 may have dimensions of less than 5 cm by 5 cm. The housing 14 is also designed to be easily stored in, for example, a pocket or purse of the user. In some embodiments, the housing 14 is formed of injection molded plastic. In other embodiments, the housing 14 may be formed of other suitable materials.

The processor 18 is positioned within and supported by the housing 14. The processor 18 is coupled to the other components of the fob 10 to control operation of the fob 10. For example, the processor 18 can interpret and condition signals received from the touchpad 26. Based on those signals, the processor 18 can instruct the transceiver 22 to send signals to remote devices to control functions of the devices, as further discussed below.

The transceiver 22 is also positioned within the housing 14 and coupled to the processor 18. The transceiver 22 sends signals to and receives signals from a remote device (e.g., a car, a door lock, an appliance, etc.) to control the device. In the illustrated embodiment, the transceiver 22 is configured to communicate with remote devices using multiple wireless protocols. More particularly, the transceiver 22 is configured to communicate using three wireless protocols: a Z-Wave® wireless protocol, a Bluetooth® wireless protocol, and a Wi-Fi™ wireless protocol. The Z-Wave® wireless protocol operates at a frequency of about 900 MHz and, more particularly, at 908.42 MHz. The Bluetooth® wireless protocol operates at a frequency of about 2.4 GHz and, more particularly, from about 2.4 GHz to about 2.485 GHz. The Wi-Fi™ wireless protocol operates at a frequency of about 2.4 GHz. In the illustrated embodiment, the transceiver 22 includes a single antenna that is configured to communicate with remote devices over each of the wireless protocols. In other embodiments, the transceiver 22 may be configured to communicate using fewer or more wireless protocols, and/or may include multiple antennas for communicating using the different wireless protocols.

The touchpad 26 is supported by the housing 14 and coupled to the processor 18. The illustrated touchpad 26 includes a capacitive sensor, although other types of touchpads may also be used. The touchpad 26 is located inside the housing 14 directly underneath an inner surface of the housing 14. As shown in FIG. 1, the touchpad 26 creates a touch area 38 on the housing 14 that detects, for example, finger movements of a user. In the illustrated embodiment, the touch area 38 takes up over half of the surface area on one side of the housing 14. In some embodiments, the touch area 38 may include indicia to identify edges of the touchpad 26. Additionally or alternatively, the indicia may include buttons, logos, and the like to help differentiate the touch area 38 from the remainder of the housing 14. In such embodiments, the indicia may be applied to the touch area 38 by silk screening.

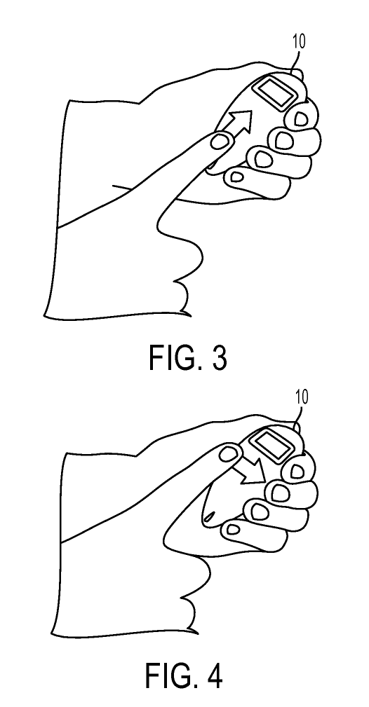

The illustrated touchpad 26 is operable to discern different gestures performed by a user. Each gesture corresponds to a different signal that is then transmitted by the transceiver 22 to a remote device. In some embodiments, up to fifty different gestures can be defined and differentiated by the touchpad 26. The gestures can include, among others, tapping different sections of touch area 38, swiping to the left, swiping to the right, swiping up, swiping down, drawing a circle, drawing a U, drawing a V, drawing an L, and the like. FIGS. 3 and 4 illustrate two different gestures being performed on the fob 10. In particular, FIG. 3 illustrates a user swiping up on the fob 10, and FIG. 4 illustrates a user swiping to the right on the fob 10. As further explained below, the various gestures can be preprogrammed into the fob 10 or can be set and defined by a user. In some embodiments, the gestures may be patterns of movements (e.g., a tap followed by a swipe).

When a gesture is performed on the touchpad 26, the transceiver 22 transmits a corresponding signal. Each gesture can be correlated to a different device and/or function of the device. For example, performing a first gesture on the touchpad 26 can cause the transmitter 22 to transmit a first signal to a remote device to initiate a first function, while performing a second gesture on the touchpad 26 can cause the transmitter 22 to transmit a second signal to the remote device to initiate a second function. In this scenario, the two functions are different, but the remote device is the same. The two functions may be, for example, unlocking a car door and opening a trunk of the car.

Alternatively, performing a first gesture on the touchpad 26 can cause the transmitter 22 to transmit a first signal to a first remote device to initiate a function, while performing a second gesture on the touchpad 26 can cause the transmitter 22 to transmit a second signal to a second remote device to initiate a function. In this scenario, the two remote devices are different, and the functions may be the same or different. The two remote devices may be, for example, a thermostat and a light in a house, and the functions may be increasing/decreasing temperature and increasing/decreasing light brightness. The above examples are intended only to be illustrative of two remote devices and two functions. It should be readily apparent that the fob 10 is usable with more than two remote devices to perform more than two different functions.

In some embodiments, one of the gestures may also be used as a password for the fob 10. In such embodiments, performing the gesture on the touchpad 26 may “login” or “unlock” the fob 10 for further use. If the fob 10 is not used for a predetermined time after the password gesture is performed (e.g., 2 minutes), the fob 10 may automatically return to its locked state.

Additionally or alternatively, the fob 10 may be programmed to allow multiple users. Each user may have access to different remote devices and/or functions associated with the remote devices. For example, one user may be able to access and control remote devices A, B, and C, while another user may only be able to access and control remote devices A and B. In addition, one user may be able to control all the functions and settings of a remote device, while another user may only be able to turn the remote device on and off. By performing certain gestures on the touch area 38, different users can log into and log off of the fob 10.

Referring back to FIG. 2, the memory 30 is also positioned within the housing 14 and coupled to the processor 18. The memory 30 can store a database of gestures and signals corresponding to the gestures. As noted above, the memory 30 can store gestures that are preprogrammed into the fob 10. The memory 30 can also store gestures that are programmed into the fob 10 by a user. For example, a user could perform a gesture on the touchpad 26 and then select which remote device and function to assign to that gesture. Allowing unique, user-defined gestures increases the security of the fob 10 by “hiding” the gestures from unauthorized or unintended users.

In some embodiments, the memory 30 may also serve as a flash drive to store data and files. In such embodiments, the memory 30 includes flash memory to store up to, for example, one gigabyte of data. The memory 30 may be configured to encrypt the data and files stored in the fob 10. The data can be transferred to and from a remote device (e.g., a computer) using the transceiver 22. When communicating with the remote device, the fob 10 will establish an ad hoc wireless connection to transfer files or other data. Alternatively, the data could be transferred via a port 42 (e.g., a USB port) formed in the housing 14 (FIG. 1). The port 14 allows a cable (e.g., a USB cable) to be plugged into the fob 10 to connect the fob 10 to another device. The port 42 and the cable can also be used to download and install, for example, firmware updates on the fob 10, or to charge the fob 10.

The power source 34 is positioned within the housing 14 to provide power to the other components of the fob 10. In the illustrated embodiment, the power source 34 is a battery. The battery 34 is rechargeable by connecting the fob 10 to another device or an outlet using, for example, the port 42 (FIG. 1) in the housing 14 and a cable. In some embodiments, the battery 34 may be removable from the fob 10 without completely disassembling or destroying the housing 14. In other embodiments, the battery 34 may be integrated into the fob 10 so that the battery 34 is not removable from the fob 10 without taking apart the housing 14.

As shown in FIGS. 1 and 2, the illustrated fob 10 also includes a display 46. The display 46 is supported by the housing 14. In the illustrated embodiment, the display 46 is located on the housing 14 adjacent the touch area 38, but is spaced apart from the touch area 38 so that the display 46 is visible to a user while interacting with the touch area 38. In some embodiments, the display 46 and the touch area 38 may be integrated into a single area. In other embodiments, the display 46 may be located elsewhere on the housing 14. The illustrated display includes an LED screen and, more particularly, an OLED screen. In other embodiments, other suitable displays, such as LCD screens, may alternatively be employed.

The display 46 is operable to display information regarding remote devices. In particular, the display 46 can display information regarding which device the fob 10 is interacting with, which function the fob 10 is attempting to control, and whether the signal from the fob 10 was successful or unsuccessful in controlling the function of the remote device. The display 46 can also function as a scroll menu or list to cycle through the remote devices that are paired and/or in communication range with the fob 10. In addition, the display 46 can display information regarding the fob 10 itself, including whether the fob 10 is locked/unlocked and a battery status (e.g., charge level) of the power source 34. Furthermore, in some embodiments, the display 46 can also display which user is currently logged into the fob 10.

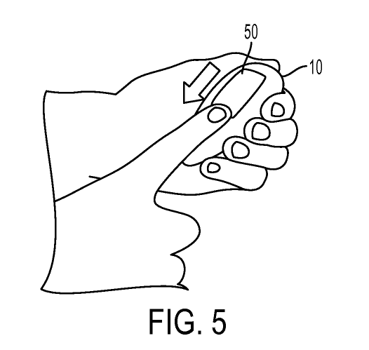

As shown in FIGS. 1 and 5, the illustrated fob 10 further includes a biometric sensor 50. The biometric sensor 50 is supported by the housing 14 and coupled to the processor 18. In the illustrated embodiment, the biometric sensor 50 is located on a rear of the housing 14, opposite from the touch area 38 and the display 46. In other embodiments, the biometric sensor 50 may be located elsewhere on the housing 14.

The illustrated biometric sensor 50 includes a fingerprint scanner. The fingerprint scanner is operable to read or detect a fingerprint of a user. The fingerprint scanner can be used to verify and authenticate a user of the fob 10. In some instances, the fingerprint scanner may be used to log a user into and unlock the fob 10. Additionally, certain remote devices and/or functions of the remote devices may also require fingerprint authentication to access. That is, performing some gestures on the touch area 38 may not actually send a corresponding signal to the remote device unless a user is also authenticated by the fingerprint scanner. Which remote device and/or functions require fingerprint authentication may be set by a user of the fob 10.

In some embodiments, the fob 10 is also a password repository. A user can input a plurality of passwords/passcodes into the memory 30 and associate the passwords/passcodes with specific devices or applications. As noted above, the memory 30 encrypts the data being stored. Using the touchpad 26 and the display 46, the user can scroll through a list of the stored passwords/passcodes. In particular, the display 46 can display names of devices and applications to which passwords/passcodes are assigned without displaying the passwords/passcodes themselves. The password/passcode can be transmitted directly to the corresponding remote device by performing a gesture on the touch area 38 or using the biometric sensor 50. In other embodiments, the password/passcode can be displayed on the display 46 and manually entered into the corresponding remote device by the user.

In some embodiments, the fob 10 can be configured to allow access to a user's smartphone. For example, the fob 10 can be used to log into and unlock the smartphone or specific apps on the smartphone. Additionally or alternatively, access to the smartphone can be prohibited unless the fob 10 is within a predetermined range (e.g., 20 meters) of the smartphone.

In further embodiments, a software development kit can be used to program the fob 10 for additional functions. For example, the fob 10 can be programmed to control other types of devices that later become available. The software development kit allows a user to continually update the fob 10 without having to redesign or upgrade the electronics of the fob 10. Updates for the fob 10 can be uploaded wirelessly or through the port 42 and a cable.

In operation, the fob 10 controls various types of devices that are capable of receiving wireless communications. As noted above, the illustrated fob 10 can communicate with Z-Wave® devices, Bluetooth® devices, and Wi-Fi™ devices. Because Z-Wave® devices operate on a mesh network, the fob 10 does not need to be in range of the specific remote device being controlled, only within range of one of the devices of the network. Performing different gestures on the touchpad 26 of the fob 10 controls different functions of the different devices. For example, one set of gestures may be associated with a first remote device, such as a user's car (e.g., a Bluetooth®-type device). These gestures could start the engine, roll up or down windows, lock or unlock doors, and pop the trunk of the car. Another set of gestures may be associated with a set of second remote device, such as appliances within a user's home (e.g., Z-wave®-type devices). These gestures could lock or unlock electric doors, turn on or off lights, turn on and off the thermostat, turn on and off a stereo, open and close window blinds, and open and close garage doors.

Since the fob 10 controls remote devices using gestures, the fob 10 is capable of controlling variable functions, rather than only binary (e.g., on/off) functions. For example, when controlling a thermostat, a user can perform a gesture (FIG. 3) on the touchpad 26 (e.g., swipe up, swipe down) to increase or decrease the temperature setting. Similarly, when controlling a light, the user can perform a gesture (FIG. 3) on the touchpad 26 (e.g., swipe up, swipe down) to dim or increase the lighting. Furthermore, when controlling a stereo, the user can perform a first gesture (FIG. 4) on the touchpad 26 (e.g., swipe left, swipe right) to increase or decrease the volume of the stereo, and a second gesture (FIG. 3) on the touchpad 26 (e.g., swipe up, swipe down) to change tracks or radio stations. A user can also scroll through a list of the remote devices that are connected to (e.g., paired with) the fob 10 and/or are within range of the fob 10 by swiping the touchpad 26 in certain directions.

Various features and advantages of the invention are set forth in the following claims.

What is claimed is:

1. A fob comprising:
a housing;
a processor positioned within the housing;
a transceiver positioned within the housing and coupled to the processor, the transceiver configured to send signals to a remote device; and
a touchpad supported by the housing and coupled to the processor, the touchpad operable to discern a plurality of different gestures, each gesture corresponding to a different signal being sent by the transceiver.

2. The fob of claim 1, wherein the transceiver sends a first signal to the remote device in response to a first gesture performed on the touchpad, and wherein the transceiver sends a second signal to the remote device in response to a second gesture performed on the touchpad, the second gesture and the second signal being different than the first gesture and the first signal, respectively.

3. The fob of claim 1, wherein the remote device is a first remote device, wherein the transceiver sends a signal to the first remote device in response to a first gesture performed on the touchpad, and wherein the transceiver sends a signal to a second remote device in response to a second gesture performed on the touchpad, the second gesture and the second remote device being different than the first gesture and the first remote device, respectively.

4. The fob of claim 1, wherein the touchpad is operable to discern a gesture that controls a variable function of the remote device.

5. The fob of claim 1, wherein the touchpad is positioned within the housing.

6. The fob of claim 1, further comprising a display supported by the housing, the display operable to display information regarding the remote device.

7. The fob of claim 6, wherein the display is spaced apart from the touchpad.

8. The fob of claim 1, further comprising a memory positioned within the housing and coupled to the processor, wherein the memory is operable to store a plurality of gestures that are defined by a user.

9. The fob of claim 1, further comprising a biometric sensor supported by the housing and coupled to the processor.

10. The fob of claim 9, wherein the biometric sensor is configured to detect a characteristic of a user, and wherein the transceiver is only operable to send at least some signals to the remote device when the characteristic of the user is detected by the biometric sensor.

11. The fob of claim 10, wherein the biometric sensor includes a fingerprint scanner.

12. A method of operating a fob, the fob including a housing, a processor positioned within the housing, a transceiver positioned within the housing and coupled to the processor, and a touchpad supported by the housing and coupled to the processor, the method comprising:
performing a first gesture on the touchpad;
transmitting, by the transceiver, a first signal in response to the first gesture;
performing a second gesture on the touchpad, the second gesture being different than the first gesture; and
transmitting, by the transceiver, a second signal in response to the second gesture, the second signal being different than the first signal.

13. The method of claim 12, wherein transmitting the first signal includes transmitting the first signal to a remote device to initiate a first function of the remote device, and wherein transmitting the second signal includes transmitting the second signal to the remote device to initiate a second function of the remote device, the second function being different than the first function.

14. The method of claim 12, wherein transmitting the first signal includes transmitting the first signal to a first remote device, and wherein transmitting the second signal includes transmitting the second signal to a second remote device that is different than the first remote device.

15. The method of claim 12, wherein transmitting the first signal includes transmitting a signal to control a variable function of a remote device.

16. The method of claim 12, wherein the fob also includes a display supported by the housing, and further comprising displaying, by the display, information regarding a remote device that is in communication with the fob.

17. The method of claim 12, wherein the fob also includes a memory positioned within the housing and coupled to the processor, and further comprising storing, by the memory, a plurality of gestures that are defined by a user.

18. The method of claim 12, wherein the fob also includes a biometric sensor supported by the housing and coupled to the processor, and further comprising detecting, by the biometric sensor, a characteristic of a user.

19. A fob comprising:
a housing;
a processor positioned within the housing; and
a transceiver positioned within the housing and coupled to the processor, the transceiver including an antenna configured to communicate with remote devices using a first wireless protocol and a second wireless protocol that is different than the first wireless protocol.

20. The fob of claim 19, wherein the antenna is also configured to communicate with the remote devices using a third wireless protocol that is different than the first and second wireless protocols.

21. The fob of claim 19, wherein the first wireless protocol operates in a frequency band of about 900 MHz.

22. The fob of claim 21, wherein the second wireless protocol operates in a frequency band of about 2.4 GHz.
